(19) United States
(12) Patent Application Publication
(10) Pub. No.: US 2021/0277879 A1
(43) Pub. Date: Sep. 9, 2021

(54) COMPRESSOR VALVE

(71) Applicant: Darren Lisle, Secret Harbour (AU)

(72) Inventor: Darren Lisle, Secret Harbour (AU)

(21) Appl. No.: 17/331,513

(22) Filed: May 26, 2021

Related U.S. Application Data
(63) Continuation of application No. PCT/AU2019/051299, filed on Nov. 27, 2019.

(30) Foreign Application Priority Data
Nov. 28, 2018 (AU) 2018904526

(51) Int. Cl. F04B 39/00; F04B 53/14; F04B 39/10

(52) U.S. Cl. CPC F04B 39/0016; F04B 39/1053; F04B 53/143

(57) ABSTRACT

A compressor valve suitable for use in a compressor is provided. The compressor valve comprises a first body member and a second body member. The first body member and the second body member each define a set of suction flow passages in fluid communication with each other between the suction passage and a cylinder of the compressor, and a set of compression flow passages in fluid communication with each other between the cylinder and the discharge passage. The valve includes a suction seal and a compression seal, both located at least partially between the first body member and the second body member. The suction seal is movable between a closed position and an open position. The suction seal is biased to a closed position against the flow of fluid from the suction passage to the cylinder. The suction seal and the compression seal are biased by helical coil springs.

### CROSS-REFERENCE TO RELATED PATENT APPLICATIONS

This patent application is a continuation of co-pending U.S. PCT Patent Application No. PCT/AU2019/051299, filed Nov. 27, 2019, which claims the benefit of Australian Patent No.: 2018904526, filed Nov. 28, 2018, the entire teachings and disclosure of which are incorporated herein by reference thereto.

### FIELD OF THE INVENTION

The present invention relates to compressor valves and in particular to an improved system for controlling fluid flow and more specifically, gas flow within the valve.

The invention has been developed primarily for use with compressor assemblies and will be described hereinafter with reference to this application. However, it will be appreciated that the invention is not limited to this particular field of use.

### BACKGROUND OF THE INVENTION

Presently, compressor valve assemblies suffer from a variety of issues relating to reliability and longevity in general. For instance in present assemblies, valve sealing plates are subject to continuous impact velocities which can lead to metal fatigue and eventual failure of said plates or at the very least a reduction in the sealing efficiency of the plates. If a plate fails this often leads to extensive damage to the compressor caused by metallic pieces from the broken valve seating plates making their way into the compressor cylinder leading to damage of the cylinder and cylinder bore among other issues. Furthermore, the ability of valve sealing plates to provide a positive seal are limited due to the generally flat profile of the sealing plates.

The present invention seeks to provide an improved valve assembly, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect, there is provided a compressor valve suitable for use in a compressor between a cylinder head including a suction passage in which a fluid flow is drawn into a cylinder under low pressure and a discharge passage to which compressed air is discharged, where in the cylinder, mechanical compression of the fluid flow is carried out to generate a high pressure fluid flow, the compressor valve comprising:
a first body member;
a second body member;
the first body member and the second body member each defining a set of suction flow passages in fluid communication with each other between the suction passage and the cylinder, and a set of compression flow passages in fluid communication with each other between the cylinder and the discharge passage;
a suction seal located at least partially between the first body member and the second body member, the suction seal being configured for at least partially restricting flow through the suction flow passages;
a compression seal located at least partially between the first body member and second body member, the compression seal being configured for at least partially restricting flow through the compression flow passages;
the suction seal being movable between a closed position in which the fluid flow through the suction passage is restricted, and an open position in which fluid flow through the suction passage is less restricted, the suction seal being biased to a closed position against the flow of fluid from the suction passage to the cylinder;
the compression seal being movable between a closed position in which the fluid flow through the compression passage is restricted, and an open position in which fluid flow through the compression passage is less restricted, the compression seal being biased to a closed position against the flow of fluid from the cylinder to the discharge passage; and
wherein the suction seal and the compression seal are biased by helical coil springs.

In one embodiment, the suction seal and the compression seal are enclosed between the first body member and the second body member.

In one embodiment, the seals comprise a plurality of buttons adapted to seal the suction flow passages and the set of compression flow passages.

In one embodiment, the suction seals and the compression seals have chamfered edges to aid with sealing.

In one embodiment, the suction seals and the compression seals are made from a polymer such as PEEK.

In one embodiment, the suction seals and the compression seals are made from thermoset polymer.

According to a further aspect, the present invention may be said to consist of a compressor valve suitable for use in a compressor between a cylinder head including a suction passage in which a fluid flow is drawn into a cylinder under low pressure and a discharge passage to which compressed air is discharged, and a cylinder in which mechanical compression of the fluid flow is carried out to generate a high pressure fluid flow, the compressor valve comprising:
a first body member;
a second body member;
the first body member and the second body member each defining a set of suction flow passages in fluid communication with each other between the suction flow passage and the cylinder, and a set of compression flow passages in fluid communication with each other between the cylinder and the discharge passage;
an annular suction seal located at least partially between the first body member and the second body member, the annular suction seal being configured for at least partially restricting flow through the suction flow passages;
an annular compression seal located at least partially between the first body member and the second body member, the annular compression seal being configured for at least partially restricting flow through the compression flow passages;
the suction seal being movable between a closed position in which the fluid flow through the suction passage is restricted, and an open position in which fluid flow through the suction passage is less restricted, the annular suction seal being biased to a closed position against the flow of fluid from the suction passage to the cylinder;
the annular compression seal being movable between a closed position in which the fluid flow through the compression passage is restricted, and an open position in which fluid flow through the compression passage is less restricted, the compression seal being biased to a closed position against the flow of fluid from the cylinder to the discharge passage; and
wherein the annular suction seal and the annular compression seal are biased by biasing arrangements spaced at least three regular intervals around their circumference.

In one embodiment, the annular suction seal and the annular compression seal are enclosed between the first body member and the second body member.

In one embodiment, the annular suction seal comprises a plurality of buttons adapted to seal the suction flow passages and the set of compression flow passages.

In one embodiment, the annular suction seals and the annular compression seals have chamfered edges to aid with sealing.

In one embodiment, the annular suction seals and the annular compression seals are made from a polymer such as PEEK.

In one embodiment, the annular suction seals and the annular compression seals are made from thermoset polymer.

In one embodiment, the first body member and the second body member are sealed using O-rings.

In one embodiment, the O-rings separate the suction flow passages from the compression flow passages.

In one embodiment, the compressor valve is substantially as herein described with reference to the accompanying drawings.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

Other aspects of the invention are also disclosed.

### BRIEF DESCRIPTION OF THE DRAWINGS

Notwithstanding any other forms which may fall within the scope of the present invention, a preferred embodiment of the invention will now be described, by way of example only, with reference to the accompanying drawings in which:

FIG. 1 is an exploded view of the compressor valve in accordance with a preferred embodiment of the present invention;

FIG. 2 is a view of the valve of FIG. 1 located in situ within the cylinder head; and

FIG. 3 is a view of a prior-art valve.

### DESCRIPTION OF EMBODIMENTS

It should be noted in the following description that like or the same reference numerals in different embodiments denote the same or similar features.

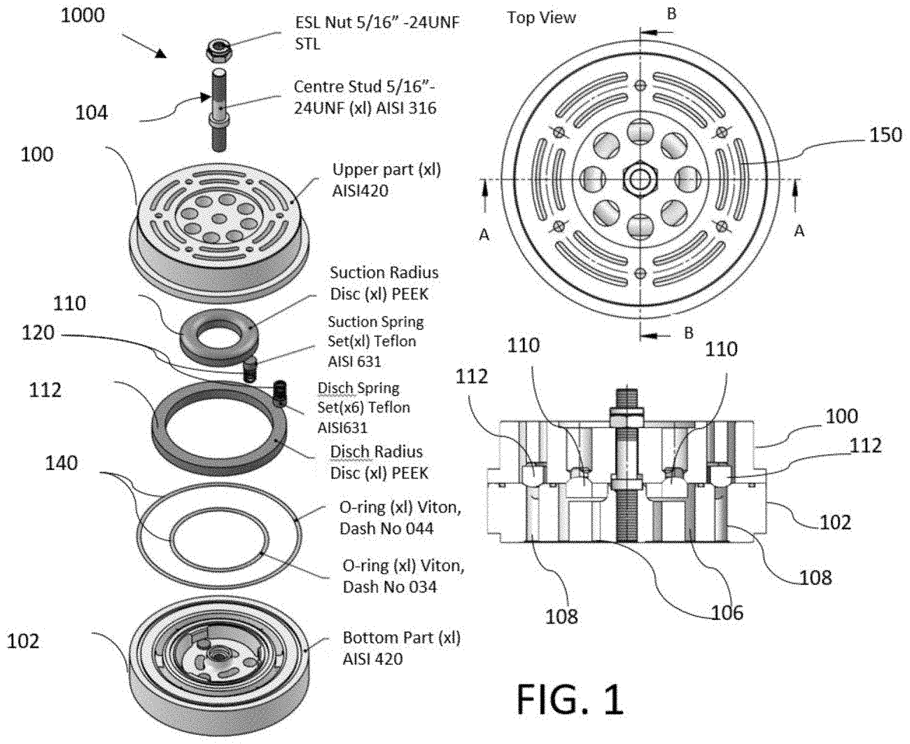

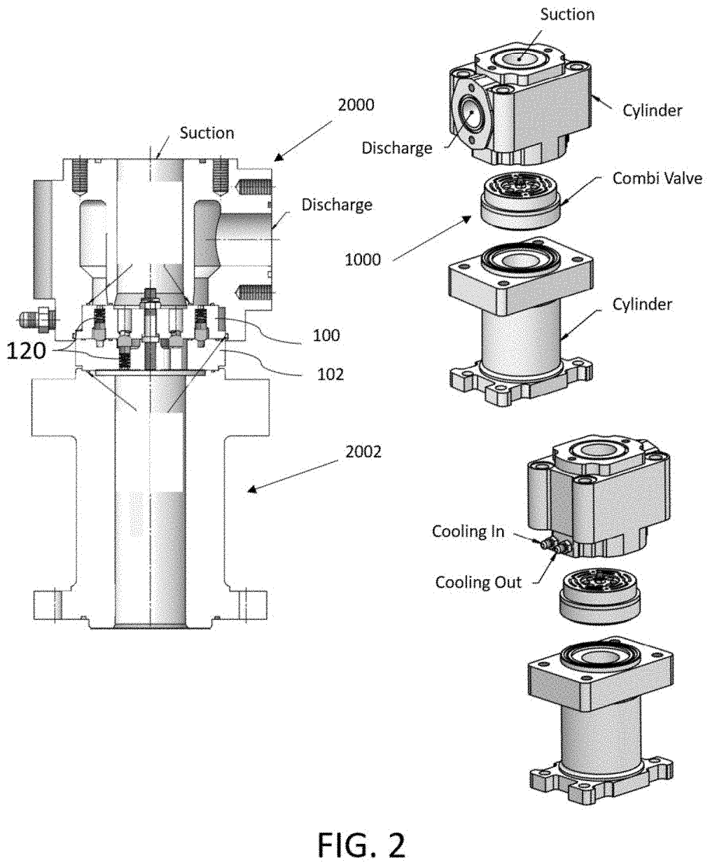

An improved compressor valve according to a first aspect of the invention is generally indicated by the numeral 1000 and is shown in FIGS. 1 and 2.

The compressor valve may be used with popular compressors such as the Atlas Copco Hurricane™ type compressors among others.

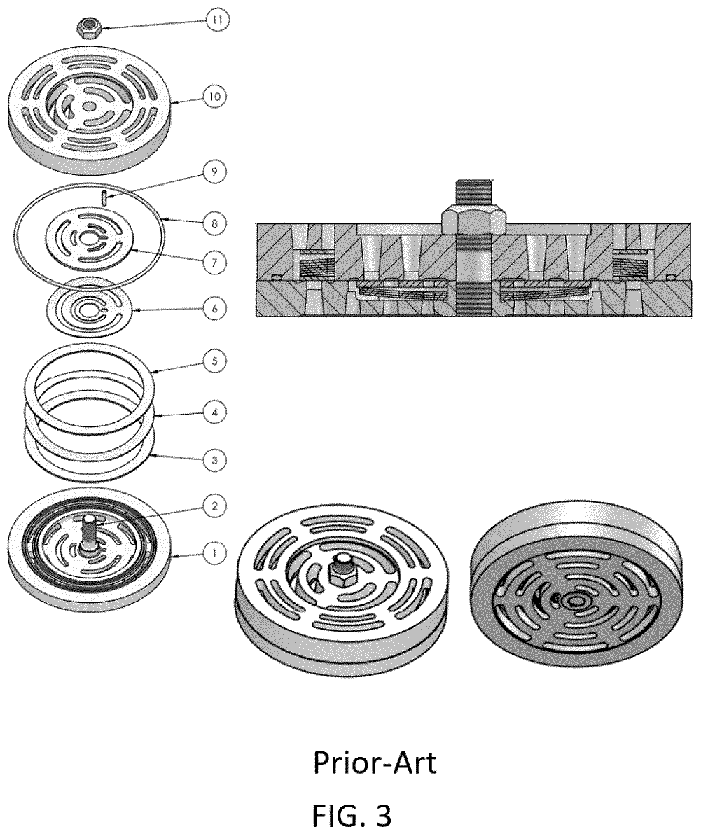

FIG. 3 illustrates a prior-art valve structure which is in common use exemplifying the differences in the valve seal design used in the prior-art as compared to the embodiments of the invention as are shown in FIGS. 1 and 2.

In one embodiment now described and shown in FIGS. 1 and 2 there is provided a compressor valve 1000 adapted for use between a cylinder head 2000 and a cylinder 2002 in which the improved compressor valve 1000 controls the flow of fluids in the form of gas between the cylinder head 2000 and the cylinder 2002.

The compressor valve 1000 comprises a first body member 100 and a second body member 102 which may be made from suitable materials such as aluminium, steel or another alloy. It is envisaged that the first and second body members 100, 102 can be produced by solid metal casting or the like.

The first body member 100 and the second body member 102 may be attached together using a fastening means such as threaded bolt 104, or screws. Notably, the first and second body members 100, 102 are also kept together by the attachment of the cylinder head 2000 to the cylinder 2002 via a clamping action which acts to clamp the first body member 100 to the second body member 102. This is provided in addition to the aforementioned fastening means, thereby reducing the load on the fastening means 104.

As can be seen in FIG. 1, the first and second body members 100, 102 comprise a plurality of passages. The passages comprise suction flow passages 106 and compression flow passages 108.

The passage of fluid which typically takes the form of a gas, is controlled by a suction seal 110 and a compression seal 112 each being located between the first body member 100 and the second body member 102. The suction seal 110 is horizontally oriented and seated in between the suction flow passages 106 and the compression seal 112 is horizontally oriented and seated in between the compression flow passages 108. In a first position or default state, both the suction seal 110 and the compression seal 112 are closed due to the pressure exerted by a biasing means in the form of a resilient member, as will be discussed below.

In the embodiment shown, the suction seal 110 and the compression seal 112 are biased in their closed position via a biasing means such as a resilient member in the form of a spring. In the embodiment shown, the suction seal 110 and the compression seal 112 are biased in their closed position via helical coil springs 120, however other biasing means may be used including: conical springs, torsion springs, or a resilient polymer.

With reference to FIG. 2, when a piston (not shown) in the cylinder 2002 moves towards the cylinder head 2000 the compression seal 112 is forced open under the pressure produced by the upward motion of the piston (not shown). As the volume within the cylinder 2002 is reduced the pressure within the cylinder 2002 increases causing the opening of the compression seal 112 and the closure of the suction seal 110. The spring tension of the helical coil springs 120 can be selected to determine at what pressure or position of piston, the compression seal 112 and the suction seal 110 opens.

Movement of the suction seal 110 from a first position or (closed position) to a second position (or open position) opens the suction seal 110, thus providing a path for gases to flow out to the discharge passage 150 when the compression seals 112 open.

The pressure generated by the upward motion of the piston (not shown) towards the cylinder head 2000 that the piston (not shown) undergoes, causes the suction seals 110 to close with the effect of restricting the passage of gas to the suction flow passages 106.

In contrast, when the piston (not shown) is travelling in the opposite direction, a partial vacuum of negative pressure is produced within the cylinder 2002. This forces the compression seals 112 to close due to the suction produced by the downward travel of the piston (not shown) away from the cylinder head 2000. The spring tension of the helical coil springs 120 also determine when the compression seal 112 and the suction seal 110 opens and can be selected accordingly. This results in the opening of the suction seals 110, allowing for the flow of gas within the suction flow passages 106 while preventing gas flow within the compression flow passages 108.

The suction seals 110 and the compression seals 112 are preferably made of a corrosion resistant material due to the environments in which the compressor valve 1000 is likely to be operated. Suitable materials may include a thermosetting plastic, a rubberised material, or polyether ether ketone (PEEK). PEEK is preferable as it is a rigid material that is resistant to corrosion and moisture.

In the embodiment shown in FIGS. 1 and 2, the suction seal 110 and the compression seal 112 are annular in shape, and particularly shaped as a torus or similar. The toroidal shape is preferable as it allows for a curved contact surface with a valve seat providing for a positive seal that is not available with prior-art valve seats such as those shown in FIG. 3. The curved contact surface may also present advantages in regards to fluid flow dynamics within the valve, reducing turbulence that may arise with prior-art valve assemblies.

As previously discussed, the suction seal 110 and the compression seal 112 both have an annular shape which in this embodiment is in the form of a torus. Due to the thickness of the annular suction seal 110 and the annular compression seal 112, the profile of each seal is more easily adapted to various different shapes and profiles. This provides for the ability to shape the profile of each of the seals in order to enhance flow dynamics, potentially reduce turbulence in the vicinity of the compressor valve 1000 and to provide a strong gas tight seal.

The radial sealing face on both the suction seal 110 and the compression seal 112 provide for a greater contact surface are and hence an improved seal in comparison to conventional seals that tend to have a flat sealing surface. Furthermore, the flow path is smoother providing less flow restrictions and better gas flow and possibly lower turbulence in the vicinity of the compressor valve 1000.

In order to achieve a positive seal, the suction seal 110 and the compression seal 112 each may have chamfered edges which may be produced using a chamfering tool applied to the seals 110, 112. The chamfering may be applied to the outer surface to the seals 110 and 112 or the chamfering may be an integral part of the design and moulded into the seals 110 and 112. As discussed before, the larger the surface area contact between the outer surface of the seal and the seat on which the seals are seated is preferably maximised by the profile of the seal and its corresponding seat. This is in contrast to the prior-art valve designs as shown in FIG. 3 where the seals comprise plates in the form of flat metallic rings (shown as 5, 4 and 3 in FIG. 3) which in the prior-art example in FIG. 3 provides a minimum surface area between the valve plate and the seat, resulting in a less than optimal seal between the valve plate and the seat.

In other embodiments, the compression seals 112 and the suction seals 110 may comprise a plurality of buttons (not shown) adapted to fit over the opening of the compression flow passages 108 and the suction flow passages 106 respectively. It is envisaged that the plurality of buttons would be biased in their closed position via a resilient member such as a coil spring, similar to that used for the suction seal 110 and the compression seal 112. The use of buttons rather than seals with an annular shape can result in a reduction in the overall weight and hence inertia experienced when the seals 110, 112 are in motion.

In other embodiments it is envisaged that the seat upon which the seals 110 and 112 are seated would be shaped with substantially the same profile as the profile of the annular seal. This provides a greater surface area contact of the seal to the seal seat resulting in a more secure seal.

In the embodiment shown, the first body member 100 and the second body member 102 are sealed against fluid flow using a plurality of O-rings 140. The O-rings 140 facilitate the separation of the compression flow passages 108 and the suction flow passages 106 from each other whilst providing a seal between the first body member 100 and the second body member 102.

### Interpretation

### Markush Groups

In addition, where features or aspects of the invention are described in terms of Markush groups, those skilled in the art will recognise that the invention is also thereby described in terms of any individual member or subgroup of members of the Markush group.

### Chronological Sequence

For the purpose of this specification, where method steps are described in sequence, the sequence does not necessarily mean that the steps are to be carried out in chronological order in that sequence, unless there is no other logical manner of interpreting the sequence.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

For the purposes of this specification, the term “plastic” shall be construed to mean a general term for a wide range of synthetic or semisynthetic polymerization products, and generally consisting of a hydrocarbon-based polymer.

As used herein the term “and/or” means “and” or “or”, or both.

As used herein “(s)” following a noun means the plural and/or singular forms of the noun.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the mechanical engineering industries.

The claims defining the invention are as follows:

1. A compressor valve suitable for use in a compressor between a cylinder head including a suction passage in which a fluid flow is drawn into a cylinder under low pressure and a discharge passage to which compressed air is discharged, where in the cylinder, mechanical compression of the fluid flow is carried out to generate a high pressure fluid flow, the compressor valve comprising:
a. a first body member;
b. a second body member;
c. the first body member and the second body member each defining a set of suction flow passages in fluid communication with each other between the suction passage and the cylinder, and a set of compression flow passages in fluid communication with each other between the cylinder and the discharge passage;
d. an annular suction seal located at least partially between the first body member and the second body member, the suction seal being configured for at least partially restricting flow through the suction flow passages;
e. an annular compression seal located at least partially between the first body member and second body member, the compression seal being configured for at least partially restricting flow through the compression flow passages;
f. the suction seal being movable between a closed position in which the fluid flow through the suction passage is restricted, and an open position in which fluid flow through the suction passage is less restricted, the suction seal being biased to a closed position against the flow of fluid from the suction passage to the cylinder;
g. the compression seal being movable between a closed position in which the fluid flow through the compression passage is restricted, and an open position in which fluid flow through the compression passage is less restricted, the compression seal being biased to a closed position against the flow of fluid from the cylinder to the discharge passage; and
h. wherein the annular suction seal and the annular compression seal are concentric;
i. wherein the suction seal and the compression seal are biased by helical coil springs; and
j. wherein the helical coil springs each include a cylindrical engaging formation movable with the spring, the engaging formation being biased by the helical coil springs for engagement against the compression seal and the suction seal.

2. The compressor valve of claim 1, wherein the suction seal and the compression seal are enclosed between the first body member and the second body member.

3. The compressor valve of claim 1, wherein the suction seal and the compression seal comprise a plurality of buttons adapted to seal the suction flow passages and the set of compression flow passages.

4. The compressor valve of claim 1, wherein the suction seals and the compression seals have chamfered edges to aid with sealing.

5. The compressor valve of claim 1, wherein the suction seal and the compression seal are composed of non-metallic material.

6. The compressor valve of claim 5, wherein the suction seals and the compression seals are made from PEEK.

7. The compressor valve of claim 1, wherein the suction seals and the compression seals are made from thermoset plastic.

8. The compressor valve of claim 1, wherein the suction seals and the compression seals are annular in shape.

9. The compressor valve of claim 1, wherein the suction seal and the compression seal are concentric.

10. The compressor valve of claim 1, wherein the first body member and the second body member are sealed using O-rings.

11. The compressor valve of claim 6, wherein the O-rings separate the suction flow passages from the compression flow passages.

12. A compressor valve suitable for use in a compressor between a cylinder head including a suction passage in which a fluid flow is drawn into a cylinder under low pressure and a discharge passage to which compressed air is discharged, where in the cylinder, mechanical compression of the fluid flow is carried out to generate a high pressure fluid flow, the compressor valve comprising:
a. a first body member;
b. a second body member;
c. the first body member and the second body member each defining a set of suction flow passages in fluid communication with each other between the suction passage and the cylinder, and a set of compression flow passages in fluid communication with each other between the cylinder and the discharge passage;
d. an annular suction seal located at least partially between the first body member and the second body member, the suction seal being configured for at least partially restricting flow through the suction flow passages;
e. an annular compression seal located at least partially between the first body member and second body member, the compression seal being configured for at least partially restricting flow through the compression flow passages;
f. the suction seal being movable between a closed position in which the fluid flow through the suction passage is restricted, and an open position in which fluid flow through the suction passage is less restricted, the suction seal being biased to a closed position against the flow of fluid from the suction passage to the cylinder;
g. the compression seal being movable between a closed position in which the fluid flow through the compression passage is restricted, and an open position in which fluid flow through the compression passage is less restricted, the compression seal being biased to a closed position against the flow of fluid from the cylinder to the discharge passage; and
h. wherein the annular suction seal and the annular compression seal are concentric;
i. wherein the suction seal and the compression seal are biased by helical coil springs; and
j. wherein the compression flow passages and the suction flow passages are sealed from each other by at least one or more O-rings disposed between the first body member and the second body member.

13. The compressor valve of claim 12, wherein each of the at least one or more O-rings are disposed in a circular channel.

14. The compressor valve of claim 13, wherein the O-rings are concentric with the compression seal and the suction seal.

15. The compressor valve of claim 12, further including an O-ring disposed outside of both the compression flow passages and the suction flow passages.

16. A compressor including the compressor valve of claim 1.

17. A compressor including the compressor valve of claim 12.
